(19) United States
(12) Patent Application Publication
(10) Pub. No.: US 2007/0085746 A1
(43) Pub. Date: Apr. 19, 2007

(54) Electrostatic Discharge Protection Receiving System

(75) Inventors: Ter-Ming Tang, Taipei City (TW); Yum-Cheng Chang, Taipei City (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Lite-On Technology Corp., Taipei (TW)

(21) Appl. No.: 11/456,173

(22) Filed: Jul. 7, 2006

(30) Foreign Application Priority Data
Oct. 19, 2005 (TW) 094218112

(51) Int. Cl. H01Q 1/26

(52) U.S. Cl. 343/701

(57) ABSTRACT

A system for receiving a signal is provided. The system includes an antenna, an amplifier, a transmission medium electrically connected between the antenna and the amplifier and an electrostatic discharge device electrically connected between the transmission line and the antenna.

### FIELD OF THE INVENTION

The present invention relates to a receiving system, and more particularly to the receiving system with an electrostatic discharge protection device.

### BACKGROUND OF THE INVENTION

Recently, the development for the communication techniques has been progressed at a tremendous pace and with giant strides and lots of wireless communication system has been presented to the public. The modern communication techniques could substantially improve the competitiveness of the industry and commerce. It is predictable that the new communication product with a greater capacity, a better communication quality and various services will be presented in the near future. For example, the transmitting and receiving devices with the services of a two-way transmission of the speech and data, a video conferencing, a video-on demand, and an internet image transmission will be provided very soon.

Nevertheless, in a communication system, since a signal transmitted from the receiving antenna to the receiver is always so weak, a signal amplifier is always provided in the receiver for amplifying the received signal. Therefore, the low-noise amplifier (LNA) is always configured at the front portion of the receiver so as to improve the possible gain and sensitivity thereof. In addition, since the noise figure of the receiver is determined at its front portion, where the low-noise amplifier is configured, the low-noise amplifier plays a role of the determinant for the receiver.

Please refer to FIG. 1, which is a diagram showing a prior receiving system for a signal. As shown in FIG. 1, the receiving system includes an antenna 11, a signal transmission line 12 and a receiving device 13. An amplifier 131 is configured at the front portion of the receiving device 13.

In the communication system, the transmission quality is always determined by the noise. Since LNA is always arranged in the front portion of the communication system, LNA always has the properties such as a high-gain, a low-noise and a high-stability. In addition, LNA also needs a specific resistance to perform a best function so as to assure the communication system under an optimum. Nevertheless, since the development of the communication system is greatly improving, the data transmission quantity is highly increasing and the operation frequency is always high, a good LNA has become a key for a high-frequency receiving device. Furthermore, in the current trend of emphasizing the simplicity, the compactness and the easy-carrying, the size of the high-frequency receiving device has become as smaller as possible. As above, how to maintain the properties of having a high-gain, a low-noise, a high-stability and a specific resistance of the LNA within the limited space of the high-frequency receiving device has become a major study object in the relevant communication industry.

Since the size of high-frequency receiving device has become more compact, the size of LNA within the receiving device is also become more compact. Nevertheless, within a compact LNA, it is difficult to maintain the relevant structure stability and the tolerance of the electrostatic discharge of LNA would reduce. As above, it is another study object in the relevant field to provide an electrostatic discharge protection to the compact LNA.

Please refer to FIG. 2, which is a diagram showing another prior receiving system for a signal. As shown in FIG. 2, the receiving system includes an antenna 21, a signal transmission line 22 and a receiving device 23. A low-noise amplifier 231 and an electrostatic discharge protection component 232 are configured at the front portion of the receiving device 23. Since the receiving device 23 is unable to afford a great capacitance and the low-noise amplifier 231 is easily destroyed by an electrostatic discharge energy, it is necessary to provide an electrostatic discharge protection component 232 to protect the receiving device 23. Nevertheless, in the current trend of emphasizing the simplicity, the compactness and the easy-carrying, the size of the receiving device 23 has become as smaller as possible and there might be no space for containing the electrostatic discharge protection component 232.

In order to overcome the defects of the conventional receiving device, it is an object of the present invention to provide a receiving system, wherein the electrostatic discharge protection device is configured to within the antenna device so as to meet the current of emphasizing compactness.

In addition, the present invention also provides an antenna device having an electrostatic discharge component therein so as to provide a protection to the amplifier connected thereto.

Furthermore, the present invention provides a communicating system including a receiving antenna device with an electrostatic discharge protection component therein.

### SUMMARY OF THE INVENTION

In accordance with one respect of the present invention, a system for receiving a signal is provided. The system includes an antenna, an amplifier, a transmission medium electrically connected between the antenna and the amplifier, and an electrostatic discharge device electrically connected between the transmission line and the antenna.

Preferably, the system further includes an antenna base connected with the antenna.

Preferably, the system further includes a repeater.

Preferably, the electrostatic discharge device is one of a diode and a resistor.

Preferably, the transmission line is a cable.

Preferably, the system is a wireless communication system.

Preferably, the amplifier is a low-noise amplifier.

Preferably, the amplifier is one selected from the group consisting of a bipolar amplifier, a complementary metal-oxide semiconductor amplifier and a complementary metal-oxide semiconductor differential amplifier.

Preferably, the electrostatic discharge device is an electrostatic discharge protection device.

Preferably, the electrostatic discharge device is grounded.

In accordance with another respect of the present invention, a system for receiving a signal is provided. The system includes an antenna device having an electrostatic discharge device therewith, a receiving device, and a transmission line electrically connected between the antenna device and the receiving device.

Preferably, the receiving device comprises a signal amplifier.

Preferably, the signal amplifier is a low-noise amplifier.

Preferably, the signal amplifier is one selected from the group consisting of a bipolar amplifier, a complementary metal-oxide semiconductor amplifier and a complementary metal-oxide semiconductor differential amplifier.

Preferably, the electrostatic discharge device is one of a diode and a resistor.

Preferably, the system is a wireless communication system.

In accordance with another respect of the present invention, an antenna device is provided. The antenna device includes an antenna, an electrostatic discharge device electrically connected with the antenna, and a base supporting the antenna.

Preferably, the antenna device is a signal receiving antenna device of a wireless communication system.

Preferably, the electrostatic discharge device is one of a diode and a resistor.

Preferably, the electrostatic discharge device is grounded.

The foregoing and other features and advantages of the present invention will be more clearly understood through the following descriptions with reference to the drawings, wherein:

### BRIEF DESCRIPTION OF THE DRAWING

FIG. 1 is a diagram showing a prior receiving system for a signal;

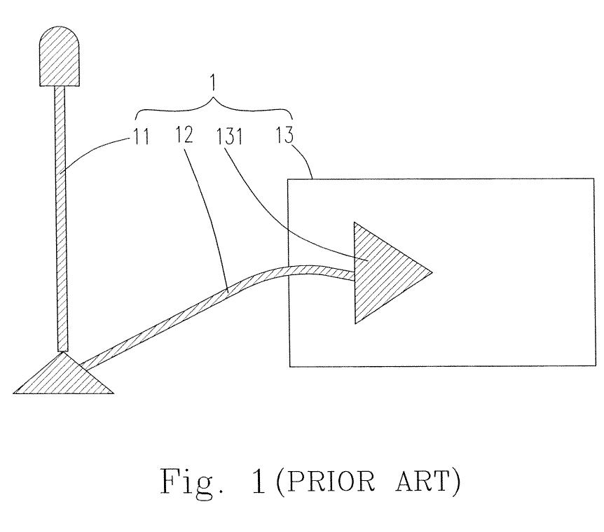

FIG. 2 is a diagram showing another prior receiving system for a signal; and

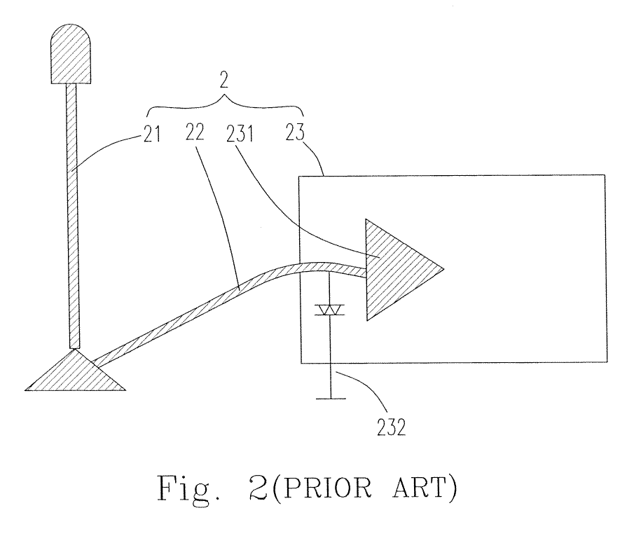

FIG. 3 is a diagram showing a system for receiving a signal according to a preferred embodiment of the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

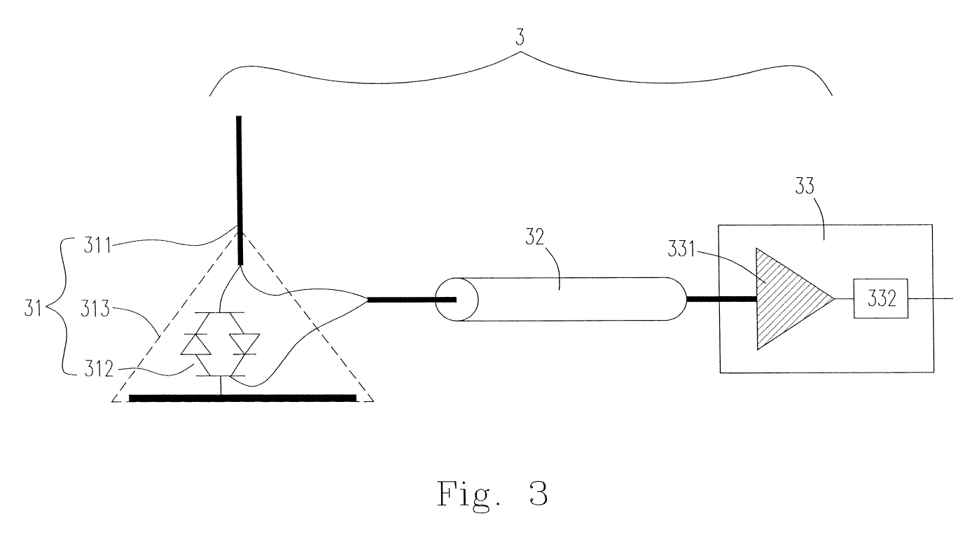

Please refer to FIG. 3, which is a diagram showing a receiving system for a signal according to a preferred embodiment of the present invention. As shown in FIG. 3, the receiving system 3 includes an antenna device 31, a transmission line 32 and a receiving device 33. The antenna device 31 includes an antenna 311, an electrostatic discharge protection element 312 and an antenna base 313. The receiving device 33 includes an amplifier 331 and the gain block 332. In this preferred embodiment, the receiving system 3 is a receiving system of a wireless communication system, the transmission line 32 is a cable, the electrostatic discharge protection element 312 is a switch diode, and the amplifier 331 is a bipolar low-noise amplifier. It should be noted, preferably, the transmission line 32 could be a coaxial cable. In addition, the electrostatic discharge protection element 312 could be a resistor, and the amplifier 331 could be one of a complementary metal oxide semiconductor (CMOS) low-noise amplifier and a CMOS differential amplifier.

In general, the electrostatic discharge protection element 312 is in a high-resistance state. When a large number of electrostatic energy is transmitted to the electrostatic discharge protection element 312, the electrostatic discharge protection element 312 would transform to be in a low-resistance sate and then the large number of electrostatic energy would be transmitted away. As shown in FIG. 3, when a signal is received by the antenna 311 and then transmitted into the antenna base 313, the electrostatic discharge protection element 312 would transform from a high-resistance state to a low-resistance state and then the large number of electrostatic energy would be transmitted to the ground via the electrostatic discharge protection element 312. Accordingly, since most of the electrostatic energy is transmitted to the ground rather than to the transmission 32, the possibility of being destroyed from the electrostatic energy of the amplifier 331 could be significantly decreased.

Since it takes a short time for the electrostatic discharge protection 312 to transform form the high-resistance state to the low-resistance state, some electrostatic energy might be transmitted into the transmission line 32. Nevertheless, since the transmission line 32 has some parasitic capacitance and parasitic inductance, most of the electrostatic energy transmitted into the transmission line 32 would be consumed thereby and then the amplifier is protected from the electrostatic energy.

Since the space limitation for the antenna device 31 is not as critical as the receiving device 33 and the electrostatic discharge protection element 312 of the preferred embodiment is mounted in the antenna device 31, the dimension limitation for the electrostatic discharge protection element 32 in the preferred embodiment is not so critical. Accordingly, with a less dimension limitation, the application field of the electrostatic discharge protection element 32 in the present application might become wider and a more powerful electrostatic protection might be provided.

As described in the above embodiment, it should be understood that when an electrostatic discharge protection element is mounted in the antenna device rather than in the receiving device, the design of the receiving device could become more compact and meet the current trends of simplicity, compactness and easy-carrying. Furthermore, since the space limitation for the antenna device is not as critical as the receiving device and the electrostatic discharge protection element of the present application is mounted in the antenna device, the electrostatic discharge protection element in the present application has with a less dimension limitation and could provide a more powerful electrostatic protection. In addition, since the dimension limitation of the antenna device is not so critical, the existing electrostatic discharge elements might be applied in the present application and no specific additional designing cost therefor is necessary. As above, the present application has the novelty, progressiveness and industry applicability.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claim is:

1. A system for receiving a signal, comprising:
an antenna;
an amplifier;
a transmission medium electrically connected between the antenna and the amplifier; and
an electrostatic discharge device electrically connected between the transmission line and the antenna.

2. The system as claimed in claim 1 further comprising an antenna base connected with the antenna.

3. The system as claimed in claim 1 further comprising a repeater.

4. The system as claimed in claim 1, wherein the electrostatic discharge device is one of a diode and a resistor.

5. The system as claimed in claim 1, wherein the transmission line is a cable.

6. The system as claimed in claim 1 being a wireless communication system.

7. The system as claimed in claim 1, wherein the amplifier is a low-noise amplifier.

8. The system as claimed in claim 1, wherein the amplifier is one selected from the group consisting of a bipolar amplifier, a complementary metal-oxide semiconductor amplifier and a complementary metal-oxide semiconductor differential amplifier.

9. The system as claimed in claim 1, wherein the electrostatic discharge device is an electrostatic discharge protection device.

10. The system as claimed in claim 9, wherein the electrostatic discharge device is grounded.

11. A system for receiving a signal, comprising:
an antenna device having an electrostatic discharge device therewith;
a receiving device; and
a transmission line electrically connected between the antenna device and the receiving device.

12. The system as claimed in claim 11, wherein the receiving device comprises a signal amplifier.

13. The system as claimed in claim 12, wherein the signal amplifier is a low-noise amplifier.

14. The system as claimed in claim 11, wherein the signal amplifier is one selected from the group consisting of a bipolar amplifier, a complementary metal-oxide semiconductor amplifier and a complementary metal-oxide semiconductor differential amplifier.

15. The system as claimed in claim 11, wherein the electrostatic discharge device is one of a diode and a resistor.

16. The system as claimed in claim 11, wherein the system is a wireless communication system.

17. An antenna device, comprising:
an antenna;
an electrostatic discharge device electrically connected with the antenna; and
a base supporting the antenna.

18. The antenna device as claimed in claim 17 being a signal receiving antenna device of a wireless communication system.

19. The antenna device as claimed in claim 17, wherein the electrostatic discharge device is one of a diode and a resistor.

20. The antenna device as claimed in claim 17, wherein the electrostatic discharge device is grounded.
